(19) United States
(12) Patent Application Publication
(10) Pub. No.: US 2009/0070762 A1
(43) Pub. Date: Mar. 12, 2009

(54) SYSTEM AND METHOD FOR EVENT-DRIVEN SCHEDULING OF COMPUTING JOBS ON A MULTI-THREADED MACHINE USING DELAY-COSTS

(76) Inventors: Peter A. Franaszek, Mount Kisco, NY (US); Dan E. Poff, Mahopac, NY (US)

Correspondence Address: F. CHAU & ASSOCIATES, LLC, 130 WOODBURY ROAD, WOODBURY, NY, 11797, US

(21) Appl. No.: 11/850,914

(22) Filed: Sep. 6, 2007

(51) Int. Cl. G06F 9/46

(52) U.S. Cl. 718/102

(57) ABSTRACT

A computer system includes N multi-threaded processors and an operating system. The N multi-threaded processors each have O hardware threads forming a pool of P hardware threads, where N, O, and P are positive integers and P is equal to N times O. The operating system includes a scheduler which receives events for one or more computing jobs. The scheduler receives one of the events and allocates R hardware threads of the pool of P hardware threads to one of the computing jobs by optimizing a sum of priorities of the computing jobs, where each priority is based in part on the number of logical processors requested by a corresponding computing job and R is an integer that is greater than or equal to 0.

### BACKGROUND OF THE INVENTION

1. Technical Field

The present disclosure relates generally to the field of computer scheduling, and more specifically to a method and system for event-driven scheduling of computing jobs on a multi-threaded machine using delay-costs.

2. Discussion of Related Art

Delay-cost (DC) is a measure used by conventional schedulers for scheduling of pending computing jobs in a computer system. Here each computing job in the system is given a time-varying measure of the (i) cost of delaying its processing or of the (ii) value of assigning a processor. The scheduler chooses a computing job to be run with the highest DC value. This approach is used successfully in single-threaded, single-cored processors, where a computing job is assigned one processor at a time. However, the tendency in modern processor design is to incorporate multiple cores on one chip, and have each core incorporate multiple hardware threads. A software thread may be dispatched for execution on a hardware thread. A computing job may include several software threads which may each be dispatched on hardware threads of a single core or distributed amongst hardware threads of multiple cores. It can be a complex task to efficiently schedule the execution of computing jobs that have several software threads on multiple cores. This task is further complicated because a typical scheduler for an operating system performs scheduling of computing jobs when events are received, rather than during fixed time periods. For example, upon receiving a job suspension event, the scheduler can then choose to allocate resources assigned to the suspended job to a current job which is in need of those resources.

Thus, there is a need for a method and a system for event-driven scheduling of threads on multi-threaded processors which incorporates delay cost.

### SUMMARY OF THE INVENTION

According to an exemplary embodiment of the present invention, a computer system includes N multi-threaded processors and an operating system. The N multi-threaded processors each have O hardware threads forming a pool of P hardware threads, where N, O, and P are positive integers and P is equal to N times O. The operating system includes an event-driven scheduler which receives events for one or more computing jobs. For each event the scheduler receives, the scheduler allocates R hardware threads of the pool of P hardware threads to one of the computing jobs by optimizing of a sum of priorities of the one or more computing jobs, where R is an integer that is greater than or equal to 0. Each priority is based on the number of logical processors requested by a corresponding computing job.

The priorities may be based on a cost that a corresponding one of the computing jobs would pay for S logical processors. Each of the S logical processors map to T hardware threads of the pool of P hardware threads, where S and T are positive integers. The cost may be based on a speed of processing the corresponding one of the computing jobs on the S logical processors. The cost may be further based on an amount of energy consumed by processing the corresponding one of the computing jobs on the S logical processors.

The cost may be chosen from a range of values bounded by a pre-defined lower limit and a pre-defined upper limit. The pre-defined upper limit can be an average cost each computing job has paid for the S logical processors over a past pre-determined period of time. The lower limit may be a fraction of the predefined upper limit.

The optimizing may include maximizing the sum of priorities or maximizing the sum of priorities subject to a fairness criterion. The N multi-threaded processors may be divided into pools of processors so the optimization can be performed separately within each processor pool. When a new computing job is received as one of the events, a load of the computer system may be balanced by dispatching the new computing job to a corresponding one of the processor pools that has a lowest pool priority. Each pool priority is based on the priorities of each of the computing jobs in the processor pool.

According to an exemplary embodiment of the present invention, an event-based scheduler for receiving events for one or more computing jobs includes an allocation unit and an assignment unit. Upon receiving one of the events, the allocation unit determines configurations of hardware resources to be used by the computing jobs according to a schedule generated by optimizing an objective function over a number logical processors requested by each of the computing jobs. The assignment unit assigns the configurations to each of the corresponding computing jobs. The objective function is based on a sum of costs that each of the computing jobs pays for the corresponding configurations.

According to an exemplary embodiment of the present invention, a method of scheduling computing jobs on a computer system includes receiving events for a plurality of computing jobs, determining a number of requested logical processors for each computing job of each received event, determining a plurality of delay-costs that each of the computing jobs will pay for an assignment of nominal processing power, determining a plurality of generalized delay-costs based on the corresponding delay-costs and the number of requested logical processors, and scheduling one or more the computing jobs to be run on the corresponding requested logical processors by optimizing a sum of the generalized delay-costs.

These and other exemplary embodiments of the present invention will be described or become more apparent from the following detailed description of exemplary embodiments, which is to be read in connection with the accompanying figures.

### BRIEF DESCRIPTION OF THE DRAWINGS

FIG. 1 is a high-level block diagram of a computer system which schedules computing jobs according to an exemplary embodiment of the present invention.

FIG. 2 is flow chart which illustrates a method of scheduling computing jobs according to an exemplary embodiment of the present invention.

FIG. 3 is table which illustrates scheduling a computing job by maximizing a sum of generalized delay-costs subject to a fairness criterion, according to an exemplary embodiment of the present invention.

FIG. 4 is table which illustrates scheduling a computing job by maximizing a sum of generalized delay-costs, according to an exemplary embodiment of the present invention.

FIGS. 5a, 5b, 5c, and 5d illustrate exemplary allocations of hardware threads to computing jobs, according to an exemplary embodiment of the present invention.

### DETAILED DESCRIPTION OF EXEMPLARY EMBODIMENTS

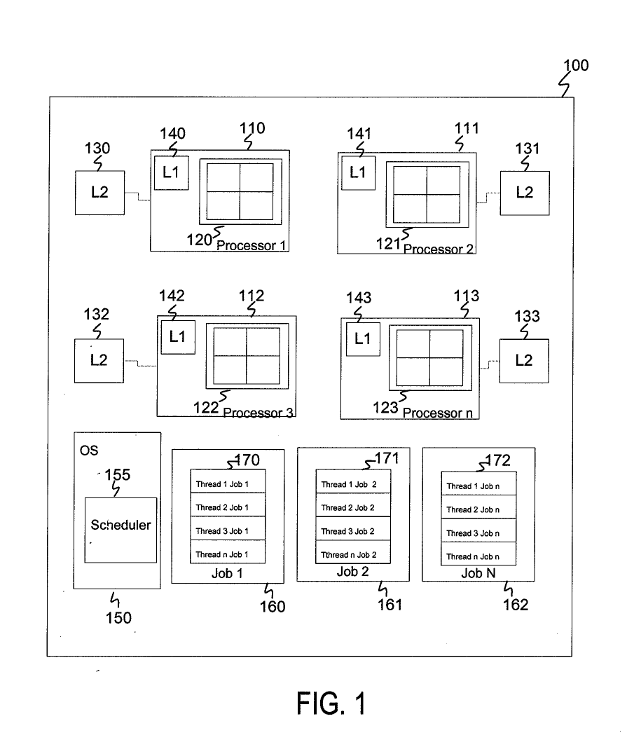

In general, exemplary embodiments systems and methods to perform event-driven scheduling of computing jobs on multi-threaded processors with now be discussed in further detail with reference to illustrative embodiments of FIGS. 1-5.

It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present invention.

FIG. 1 is a high-level block diagram of a computer system 100, according to an exemplary embodiment of the present invention. Referring to FIG. 1, the computer system 100 includes multi-threaded processors 110, 111, 112, 113, L1 caches 140, 141, 142, 143, L2 caches 130, 131, 132, 133, an operating system 150, and one or more computing jobs 160, 161 and 162. The multi-threaded processors 110, 111, 112, 113 include corresponding groups of hardware threads 120, 121, 122, 123 for executing software threads 170, 171, 172 of the computing jobs 160, 161, 162.

The operating system 150 includes an event-driven scheduler 155 which provides resources of the computer system to the computing jobs 160, 161, 162. The event-driven scheduler 155 schedules one or more of the computing jobs 160, 161, 162 to be run on a portion of the hardware threads 120, 121, 122, 123.

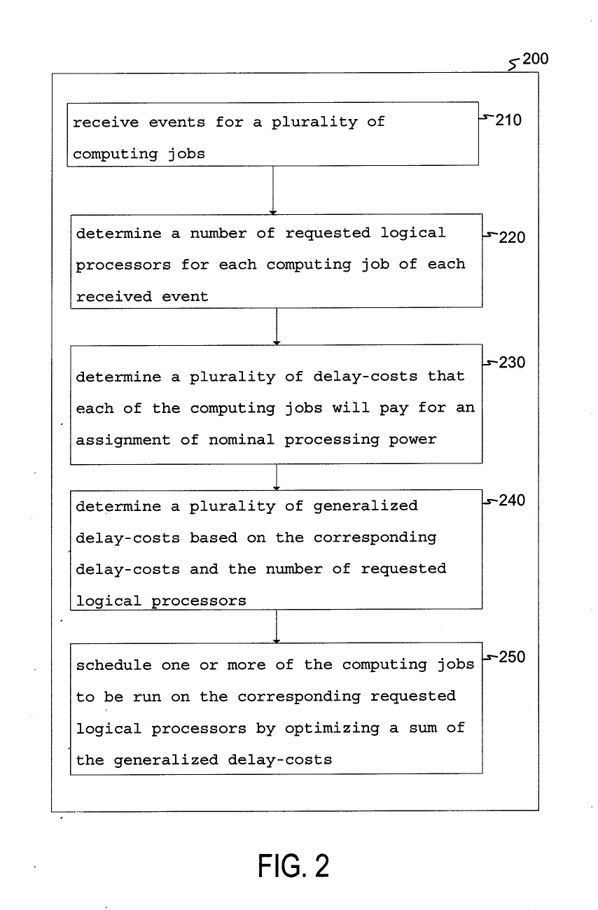

Exemplary modes of operating the system of FIG. 1 will now be explained with reference to FIG. 2. Although the computer system 100 of FIG. 1 illustrates a certain number of processors, L1 caches, L2 caches, hardware threads, software threads, and computing jobs, it is to be understood that FIG. 1 is merely an illustrative embodiment and there can be any number of processors, L1 caches, L2 caches, hardware threads, software threads, and computing jobs depending on the application.

FIG. 2 is flow chart which illustrates a method 200 of scheduling computing jobs, according to an exemplary embodiment of the present invention. The method 200 may be implemented by the event-driven scheduler 155 in the computer system 100 of FIG. 1 for scheduling the computing jobs 160, 161, 162 to be run on the groups of hardware threads 120, 121, 122, 123. The method 200 will be discussed in relation to FIGS. 1 and 2.

Referring to FIG. 2, the event-driven scheduler 155 receives events relating to the computing jobs 160, 161, 162 (step 210), determines a number of requested logical processors for each computing job for each received event (step 220), determines a plurality of delay-costs that each of the computing jobs will pay for an assignment of nominal processing power (step 230), determines a plurality of generalized delay-costs based on the corresponding delay-costs and the number of requested logical processors (step 240), and schedules one or more of the computing jobs to be run on the corresponding requested logical processors by optimizing a sum of the generalized delay-costs (step 250).

The events received by the event-driven scheduler 155 may come from several places, such as from the arrival of a new job, a timer interrupt signaling an end of time-slice, device interrupts indicating i/o completion or input from a user terminal, etc. The events can include events such as, a completion of time slice event, a job suspension event, a new job arrival event, a change in delay-cost event, etc. A completion of time slice event may indicate that a slice of processing time allocated to a particular computing job has expired. The job suspension event may indicate that a computing job has been suspended. The new job arrival event may indicate that a new computing job has been started. A change in delay-cost event may indicate various cost related changes, such as the new cost of power due to a brownout or changes in cost due to the time of day. The time of day can effect the cost of delaying a computing because a system may perform different duties throughout the day. For example, batch jobs often run at night, while interactive services often run during the day.

Upon receipt of one of these events, the generalized delay-costs can be recalculated. The event-driven scheduler 155 can then determine which, if any job to dispatch, how many hardware threads it should use, and which core or hardware thread should be assigned based on an optimization of a sum of the re-calculated generalized delay-costs. For example, the scheduler 155 may determine that it is more efficient to run one computing job on a single chip and another computing job on multiple chips.

The computing jobs 160, 161, 162 can request any number of logical processors. A logical processor represents a number of hardware threads of each multi-threaded processor 110-113 of the computer system 100. The number is based on the allocation type of the request. For example, a computing job could request 2 logical processors of allocation type 1, where each logical processor maps to 1 hardware thread. If the event-driven scheduler 1155 were to honor such a request, one fourth of two multi-threaded processors would be allocated to the computing job because each of the illustrated multi-threaded processors has 4 cores.

The event-driven scheduler 155 determines the delay-costs C(i,t) that the computing jobs J(i) 170, 171, 172 are willing to pay at a time t for an assignment of nominal processing power. If the delay-costs C(i,t) remain constant during a scheduling period T, the delay-costs can be denoted C(i).

The event-driven scheduler 155 determines the generalized delay-costs for each of the computing jobs J(i) based on each of the corresponding delay-costs and each of the corresponding logical processors requested by the computing jobs J(i).

The generalized delay-costs may be further based on a speed of processing a corresponding one of the computing jobs J(i) on the hardware threads 120, 121, 122, 123 of the multi-threaded processors 110, 111, 112, 113. The speed may be a normalized expected speed v(i,j) of processing a computing job on an allocation of type j. An allocation of type j means that a requested logical processor maps to j hardware threads. One would expect v(i,j) to be greater than v(i,k) if j is greater than k because the more hardware threads allocated a computing job, the faster the speedup. This expectation is supported by such factors as decreased sharing of caches and execution units in the multi-threaded processors 110, 111, 112, 113. A generalized-delay cost Z₁(i,j) based on a normalized speed v(i,j) may be expressed by the following equation 1:

Z₁(i,j)=v(i,j)×C(i) (1)

where Z₁ can be viewed as the advantage accrued to the computer system 100 by running a computing job J(i) with relative speed v(i,j).

The generalized delay-costs may be further based on a energy cost of processing a corresponding one of the computing jobs J(i) on allocated hardware threads of the of the multi-threaded processors 110, 111, 112, 113. The energy costs may be a normalized energy cost U(i,j) of processing a computing job J(i) on an allocation of type j. For example, using two multi-threaded processors is likely to use more energy than just using one. An energy cost can be simplified by assuming it to be a constant or the sum of some system constant (i.e., for memory, I/O, power supplies, etc.) plus a term which is proportional to the number of multi-threaded processors allocated. A generalized-delay cost Z₂(i,j) based on a normalized speed v(i,j) and a normalized energy U(i,j) may be expressed by the following equation 2:

Z₂(i,j)=v(i,j)×C(i)−U(i,j) (2)

where Z₂ can be viewed as the advantage accrued to the computer system 100 by running a computing job J(i) with relative speed v(i,j) and with relative power U(i,j). The greater the speed, the greater the advantage, adjusted by the cost of the power required.

The event-driven scheduler 155 schedules one or more of the computing jobs J(i) to be run on hardware threads of the multi-threaded processors 110, 111, 112, 113 by optimizing a sum of the generalized delay-costs Z(i,j) of each the computing jobs J(i).

The optimization of the generalized delay-costs Z(i,j) can be performed by a first approach which maximizes the sum of the generalized delay-costs Z(i,j) subject to a fairness criterion. Hardware threads are allocated at a maximum cost for which there is sufficient demand. Q(i,j) is referred to as the normalized cost Z(i,j) per hardware thread allocated. If a computing job J(i) is allocated resources at a price Q(i,j) per hardware thread, no J(r) is required to pay an amount Q(k,r) if there is a feasible allocation A(r,s) for J(r) with Q(i, j)<=Q(r,s)<Q(k,r). This is similar to assigning more than one priority to a computing job J(i), as a function of the resources that need to be allocated. Here a job is assigned resources corresponding to its lowest priority required to run.

The demand from a computing job J(i) for threads at a price Q is the maximum number of hardware threads corresponding to a value Q(i,j)>=Q. The clearing price Q* is the highest value of Q at which total demand for threads is equal to or greater than the amount available. As the price Q is lowered, the demand increases. However, if the price Q drops too low, then all of the available hardware threads may be allocated to just one computing job, producing congestion for later arrivals. For example, in a system with only one active computing job, the clearing price Q* would continue to drop until all of the available hardware threads were allocated to just the one computing job, leaving nothing for a new computing job. The price Q that a computing job J(i) is willing to pay for an allocation of hardware threads can be set as to not exceed a pre-determined threshold to reduce deleterious fluctuations in the assignment of resources when there are fluctuations in the arrivals of new computing jobs. For example, the price Q can be limited to a pre-defined lower limit cost, or an average cost or percentage of an average cost of the computing job as measured during a pre-determined time period. If the system has multiple job pools, the price Q can be limited by an average cost or percentage of an average cost for the pool of computing jobs that the computing job is within.

The first approach can be implemented by using the following procedure. For each computing job J(i), determine the highest value of Q at which this job's demand corresponds to an allocation of type j. Next, determine the clearing price Q* by obtaining the total demand at each Q. Finally, choose an allocation of not more than 4N hardware threads with the greatest Qs.

The procedure of the first approach can be implemented using the following first method having a complexity of O(M²). For each computing job J(i), obtain the values L(i,j) and Q(i,j) for j=1,2,3,4, where L(i,j) is the number of hardware threads corresponding to an allocation of type j for a computing job J(i). Next enter the values for Q(i,j) and L(i,j) in a row V(i) of a matrix V, ordered by decreasing value of Q. Next, starting with the first column of V, and for every column until the demand exceeds 4N, for each value of Q(i,j) in this column, determine the largest L(p,q) in each row which corresponds to a Q(p,q) not smaller than Q(i,j). The sum of the obtained L(p,q) is the demand at price Q(i,j). Next, if the total allocation is greater than 4N, reduce the demand by not scheduling one or more computing jobs J(i), or by giving some computing jobs J(i) a smaller allocation. This can be done by choosing jobs with the lowest value of Q.

The procedure of the first approach can be alternately implemented using the following second method having a complexity of O(MLogM). For each computing job J(i), obtain the values L(i,j) and Q(i,j) for j=1,2,3,4. Next enter the values for Q(i,j) and L(i,j) in a row V(i) of a matrix V, ordered by decreasing value of Q. Next, sort the Qs in the matrix V and via a binary search on the sorted Qs, find the largest Q corresponding to a demand of at least 4N.

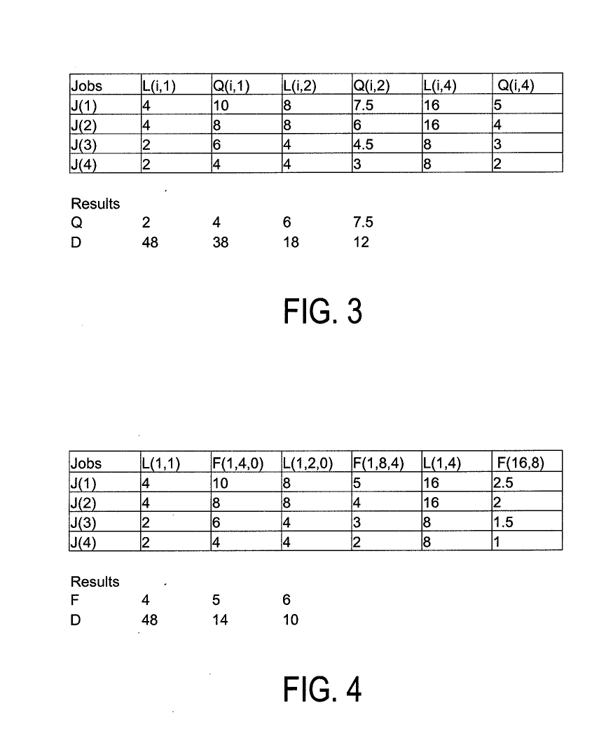

FIG. 3 is a table which illustrates the use of the procedure of the first approach, where N=3, each multi-threaded processor has 4 hardware threads, and four computing jobs J(1), J(2), J(3), J(4) are present. Referring to FIG. 3, the results show that a price of 7.5 corresponds to a demand of 12, which is the number of available hardware threads. This would correspond to two multi-threaded processors being granted to computing job J(1) and one to computing job J(2).

The optimization of the generalized delay-costs Z(i,j) can be performed by a second approach which maximizes the sum of the generalized delay-costs Z(i,j), with no uniformity. The second approach can be implemented by considering the marginal advantage, per hardware thread, of allocating additional hardware threads to a given computing job J(i). This advantage is defined by the following equation 3:

F(i,m,n)=(L(i,m)Q(i,m)−L(i,n)Q(i,n))/m−n) (3)

where F is the marginal per hardware thread advantage of additional hardware threads to a given computing job J(i).

The second approach can be implemented using the following method. For each computing job J(i), obtain the values L(i,m) and F(i,m,n) for m,n=1,2,3,4 where m is greater than n. Next, enter the quantities F(i,m,n) into a sorted list. Next, via a binary search on the sorted Fs, find the largest F corresponding to a demand of at least 4N. Next, if the total allocation is greater than 4N, reduce the demand by not scheduling a job, or giving it a smaller allocation. The demand from a computing job J(i) for threads at a marginal price F is the number of hardware threads corresponding to a value F<=F(i,m,n). When the incremental advantage is F, then m hardware threads can be allocated. The least value of F at which the total demand for threads is equal to or greater than the amount available is the clearing marginal price F*.

Results of the method of the second approach are illustrated in the table in FIG. 4. Referring to FIG. 4, the marginal clearing price F*=5, computing job J(1) is allocated 8 hardware threads, computing job J(2) is allocated 4 hardware threads, and computing job J(3) is allocated 2 hardware threads. However, this sums to 14, which is more than the 12 that are available. To obtain an allocation, one could allocate 4 hardware threads to computing job J(1), or use the first approach, with the computing jobs J(3) and J(4) denied processing. However, if the system had 14 hardware threads available, the above results would have been optimal.

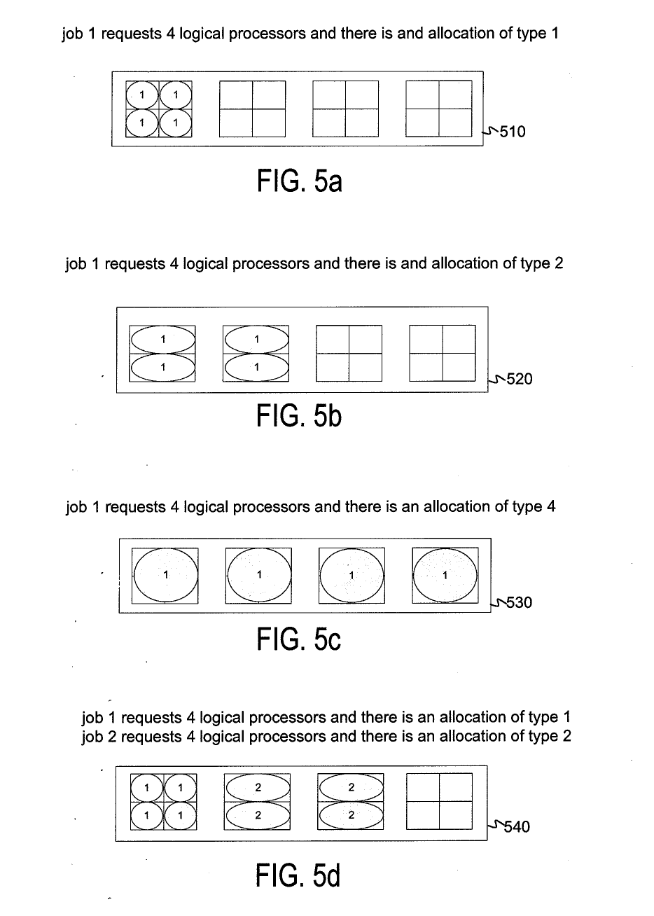

By implementing the above first or second approach, the event-driven scheduler 155 determines the allocation types for each of the computing jobs 160, 161, 162. FIGS. 5a-5d illustrate exemplary allocation types that the event-driven scheduler 155 may have chosen to satisfy the requests of the computing jobs 160, 161, 162.

In FIGS. 5a-5c, a computing job 1 requests four logical processors. FIG. 5a schematically illustrates an exemplary allocation of type j=1 510 by the event-driven scheduler 155. Since j=1, each of the logical processors represents one hardware thread for a total allocation of four hardware threads. While FIG. 5a illustrates a single multi-threaded processor 110 being allocated to the computing job 1, the scheduler 155 could have allocated fractions of the multi-threaded processors 110, 111, 112, 113. For example, half of the first multi-threaded processor 110 could have been allocated for two software threads of the computing job 1, while half of the second multi-threaded processor 111 could have been allocated to another two software threads of the computing job 1.

FIG. 5b schematically illustrates an allocation of type j=2 520 by the scheduler 155. Since j=2, each of the logical processors represents two hardware thread for a total allocation of eight hardware threads.

FIG. 5c schematically illustrates an exemplary allocation of type j=4 530 by the scheduler 155. Since j=4, each of the logical processors represents four hardware thread for a total allocation of sixteen hardware threads.

FIG. 5d schematically illustrates an allocation of type j=1 and type j=2 540 respectively, for a computing job 1 and a computing job 2, which each request four logical processors. Since j=1 for computing job 1, the logical processors requested by computing job 1 represent one hardware thread for an allocation of four hardware threads to computing job 1. Since j=2 for computing job 2, the logical processors requested by computing job 2 represent two hardware threads for an allocation of eight hardware threads to computing job 2.

The differences between the first and second approaches can be illuminated by way of the following example. Suppose there are N multi-threaded processors, each with 2 hardware threads, and some number of computing jobs J(i), each requiring a single logical processor. A shadow job sJ(i) can be associated with each computing J(i), which represents the gain from having J(i) running alone on a multi-threaded processor. Under the first approach, a computing job J(i) and its shadow would run if their average cost was in the top 2N. The second approach would choose the top 2N jobs among the {J(i), sJ(i)}, so that a computing job J(i) and its shadow would be chosen if each was in the top 2N, meaning that a computing job J(i) might be required to pay more for resources than another computing job J(k).

Once an allocation has been obtained, an assignment of hardware threads to a computing job J(i), e.g., a guest operating system, may be made to preserve special locality to the extent possible. For example if 4 hardware threads are assigned to a computing job J(i), then these may be assigned on the same multi-threaded processor. More generally, if the number of identical multi-threaded processors on a chip is a power of two and the number of chips on a computer node is also power of two, then a buddy system for thread assignment may be used.

In a buddy system for thread assignment, the number of hardware threads is maintained in neighboring collections of powers of two, in much the same way as a buddy system for dynamic storage allocation. Thread assignment can be done as in memory assignment, for example in order of decreasing allocation. An alternative would be to assign groups of hardware threads in order of decreasing per thread cost. Some method of the latter type may be necessary if running computing jobs J(i) are permitted to remain on their assigned processors from period to period. At each time t, some computing jobs J(i) may complete, and others may receive a different allocation. A change in allocation would provide an opportunity to merge buddies into larger allocatable units.

For affinity reasons, if a computing job J(i) is allocated the same number of hardware threads as in the previous period T, it may be given the same assignment. B(i) may be assumed to be the number of entries into a buddy class for 2ⁱ hardware threads. The buddy class of i=2 may be comprised of entire multi-threaded processors, with i=1 and i=0 comprised of half multi-threaded processors and single hardware threads. Buddy classes for i>2 can be made neighbors on a chip.

If scheduling is being performed for some period T, the thread assignment in the previous period may be considered. If the allocation is unchanged from the previous period, the assignment during the next period can be the same as before. The remaining threads may be gathered into buddy clusters. Then computing jobs J(i) may be sorted according to the number of hardware threads allocated, and in the order of decreasing thread allocation, hardware threads may be assigned to meet the allocation with the least number of breakups of member buddy classes.

It is be understood that the particular exemplary embodiments disclosed above are illustrative only, as the invention may be modified and practiced in different but equivalent manners apparent to those skilled in the art having the benefit of the teachings herein. Furthermore, no limitations are intended to the herein described exemplary embodiments, other than as described in the claims below. It is therefore evident that the particular exemplary embodiments disclosed herein may be altered or modified and all such variations are considered within the scope and spirit of the invention. Accordingly, the protection sought herein is as set forth in the claims below.

What is claimed is:

1. A computer system, comprising:
N multi-threaded processors, the N multi-threaded processors each having O hardware threads forming a pool of P hardware threads, wherein N, O, and P are positive integers and P is equal to N times O; and
an operating system comprising a scheduler which receives events for one or more computing jobs, the scheduler receiving one of the events and allocating R hardware threads of the pool of P hardware threads to one of the computing jobs by optimizing a sum of priorities of the computing jobs, wherein each priority is based on the number of logical processors requested by a corresponding computing job and R is a positive integer that is greater than or equal to zero.

2. The computer system of claim 1, wherein the priorities are further based on a cost that a corresponding one of the computing jobs would pay for S logical processors, each of the S logical processors mapping to T hardware threads of the pool of P hardware threads, wherein S and T are positive integers.

3. The computer system of claim 2, wherein the cost is chosen from a range of values bounded by a pre-defined lower limit and a pre-defined upper limit, the pre-defined upper limit being an average cost each computing job has paid for the S logical processors over a past pre-determined period of time.

4. The computer system of claim 2, wherein the cost is based on a speed of processing the corresponding one of the computing jobs on the S logical processors.

5. The computer system of claim 4, wherein the cost is further based on an amount of energy consumed by processing the corresponding one of the computing jobs on the S logical processors.

6. The computer system of claim 1, wherein the optimizing comprises maximizing the sum of priorities.

7. The computer system of claim 1, wherein the optimizing comprises maximizing the sum of priorities subject to a fairness criterion.

8. The computer system of claim 1, wherein the N multi-threaded processors are divided into pools of processors and the optimization is performed separately within each processor pool.

9. The computer system of claim 1, wherein when a new computing job is received as one of the events, the scheduler balances a load of the computer system by dispatching the new computing job to a corresponding one of the processor pools that has a lowest pool priority, wherein each pool priority is based on the priorities of each of the computing jobs in the processor pool.

10. An event-based scheduler receiving events for one or more computing jobs, the scheduler comprising:
an allocation unit, which upon receiving one of the events, determines configurations of hardware resources to be used by the computing jobs according to a schedule generated by optimizing an objective function over a number logical processors requested by each of the computing jobs; and
an assignment unit assigning the configurations to each of the corresponding computing jobs,
wherein the objective function is based on a sum of costs that each of the computing jobs pays for the corresponding configurations.

11. The event-based scheduler of claim 10, wherein each of the costs is chosen from a range of values bounded by a pre-defined lower limit and a pre-defined upper limit, the pre-defined upper limit being an average cost each computing job has paid for a corresponding configuration over a past pre-determined period of time.

12. The event-based scheduler of claim 10, wherein each logical processor maps to a number of hardware threads of a multi-threaded processor.

13. The event-based scheduler of claim 10, wherein each of the costs is based on a speed of processing a corresponding one of the computing jobs on the number of logical processors.

14. The event-based scheduler of claim 13, wherein each of the costs is further based on an amount of energy consumed by processing the corresponding one of the computing jobs on the number of the number of logical processors.

15. The event-based scheduler of claim 10, wherein the optimizing comprises maximizing the objective function.

16. The event-based scheduler of claim 10, wherein the optimizing comprises maximizing the objective function subject to a fairness criterion.

17. A method of scheduling computing jobs on a computer system, comprising:
receiving events for a plurality of computing jobs;
determining a number of requested logical processors for each computing job of each received event;
determining a plurality of delay-costs that each of the computing jobs will pay for an assignment of nominal processing power;
determining a plurality of generalized delay-costs based on the corresponding delay-costs and a number of requested logical processors; and
scheduling one or more the computing jobs to be run on the corresponding requested logical processors by optimizing a sum of the generalized delay-costs.

18. The method of claim 17, wherein each generalized delay-cost is chosen from a range of values bounded by a pre-defined lower limit and a pre-defined upper limit, the pre-defined upper limit being an average delay-cost each computing job has paid for the number of logical processors over a past pre-determined period of time.

19. The method of claim 17, wherein each of the generalized delay-costs is further based on a speed of processing a corresponding one of the computing jobs on the corresponding requested logical processors.

20. The method of claim 17, wherein the optimizing comprises maximizing the sum of the generalized delay-costs.
